(19) United States
(12) Patent Application Publication
(10) Pub. No.: US 2017/0195794 A1
(43) Pub. Date: Jul. 6, 2017

(54) WIRELESS AVIATION HEADSET

(71) Applicant: Light Speed Aviation, Inc., Lake Oswego, OR (US)

(72) Inventors: Eduard VAYNBERG, Portland, OR (US); John C. ELLIOT, Portland, OR (US)

(21) Appl. No.: 15/339,126

(22) Filed: Oct. 31, 2016

Related U.S. Application Data
(60) Provisional application No. 62/253,129, filed on Nov. 9, 2015.

(51) Int. Cl. H04R 5/033; G06F 3/16

(52) U.S. Cl. CPC H04R 5/033; G06F 3/162; H04R 2460/01; H04R 2201/107; H04R 2420/07; H04R 2430/03

(57) ABSTRACT

An aircraft wireless communication system includes a headset having an active noise reduction (ANR) microphone, ANR circuitry coupled to the ANR microphone that generates a driver signal in response to the signal from the ANR microphone, a driver coupled to the ANR circuitry that receives the driver signal, a digital receiver coupled to the ANR circuitry, a voice microphone, and an analog transmitter coupled to the voice microphone. The system also includes an aircraft panel interface having an analog receiver that receives wireless signals from the analog transmitter and provides corresponding signals to a wired output configured to connect to an aircraft panel, and a digital transmitter connected to a wired input configured to connect to an aircraft panel and wirelessly transmit corresponding signals to the digital receiver. The system may include a left-to-right cross-feed circuit for selected frequencies to improve speech intelligibility.

### CROSS-REFERENCE TO RELATED APPLICATIONS

This application claims the benefit of U.S. provisional application Ser. No. 62/253,129 filed Nov. 9, 2015, the disclosure of which is hereby incorporated in its entirety by reference herein.

### BACKGROUND AND SUMMARY

Active noise reduction (ANR) or active noise cancellation (ANC) devices have been commercially available for many years. In general, these devices use electronics to generate a signal with the same amplitude but opposite phase of the noise. This is accomplished using a closed loop feedback and/or feedforward control system having a sensing microphone to detect the noise with the associated signal passed through electronics to drive a speaker that produces a pressure wave out of phase with the noise, resulting in a net reduction, attenuation, or cancellation of the noise perceived by a user.

Many aviation headsets employ ANR technology to reduce noise associated with aircraft operation and to provide communication both within the aircraft cabin and externally to communicate with air traffic control, for example. Traditional aviation headsets employ at least one cord connecting the headset to the aircraft panel to provide power as well as communication signals. Cord connections necessarily restrict or limit movement of the user relative to the aircraft panel. Availability of wireless aviation headsets has been limited due to various design challenges. One such challenge with wireless aviation communication systems is that pilots rely on hearing a sidetone (reproduction of their own voice) after the audio signal has been sent to the aircraft intercom and returned back from the intercom. With traditional wireless technology solutions the delay (latency) of sending the signal to the intercom and receiving the signal back from the intercom results in an audible delay that reduces speech intelligibility.

As such, various embodiments according to the present disclosure provide a system and method for wireless aviation communication between a user and an aircraft panel that reduces the delay or latency of the sidetone using an analog wireless link in combination with a digital wireless link between the headset and the aircraft panel.

In one embodiment, a system includes a headset that communicates wirelessly with an aircraft panel interface, which plugs into the aircraft intercom connection of the aircraft panel. The headset includes active noise reduction or cancellation circuitry coupled to a driver and ANR microphone, an analog transmitter for sending a (voice) microphone signal to the intercom via a wireless receiver in the panel interface, a digital receiver for receiving an intercom signal from the panel interface, a battery with a charging port, volume controls, and function controls. The panel interface includes jacks for connecting to the aircraft intercom of the aircraft panel, an analog receiver to receive the wireless microphone signal from the headset, and a digital transmitter for sending audio to the headset. In various embodiments, the wireless receiver contains a Bluetooth auxiliary audio input and a wired auxiliary input. Both auxiliary inputs are capable of communicating audio signals to and/or from a connected nomadic device, such as a smart phone, watch, or other portable or wearable device. The aircraft panel interface may be battery powered and include a charging port. An optional cable may be provided for backup communications between the headset and panel interface with the cable connecting the headset directly to the intercom, bypassing the active circuitry.

Various embodiments may include a left-to-right cross-feed circuit that combines selected frequencies from the left stereo channel with the signal from the right stereo channel, and selected frequencies from the right stereo channel with the signal from the left stereo channel. This results in voice components of the signal becoming mono to improve speech intelligibility while preserving the stereo nature of the remaining signal frequencies to provide high quality auxiliary music playback.

In one embodiment, an aircraft wireless communication system includes a headset comprising left and right active noise reduction (ANR) microphones, ANR circuitry coupled to the left and right ANR microphones that processes signals from the ANR microphones to generate corresponding driver signals in response to the signals from the ANR microphones, left and right drivers coupled to the ANR circuitry that receive respective left and right driver signals, a digital receiver coupled to the ANR circuitry, a voice microphone, and an analog transmitter coupled to the voice microphone. The system also includes an aircraft panel interface comprising an analog receiver that receives wireless signals from the analog transmitter and provides corresponding signals to a wired output configured to connect to an aircraft panel, and a digital transmitter connected to a wired input configured to connect to an aircraft panel and wirelessly transmit corresponding signals to the digital receiver.

Embodiments may also include a method for aircraft wireless communication, comprising wirelessly transmitting analog voice signals from a headset to an analog receiver of an aircraft panel interface module configured for wired coupling to an aircraft panel, and wirelessly transmitting digital signals from the aircraft panel interface module to the headset. The method may also include combining bandpass filtered signals from a left channel with unfiltered signals from a right channel of a headset digital receiver, and combining bandpass filtered signals from the right channel with unfiltered signals from the left channel of the headset digital receiver. In one embodiment, the bandpass filtered signals are filtered to pass frequencies between 300 Hz and 1.5 kHz. The method may also include transmitting signals from the aircraft interface module to the headset from a wirelessly linked mobile device.

Embodiments according to the present disclosure provide various advantages. For example, combining analog and digital wireless links results in a total latency that is acceptable to most users with minimal impact on speech intelligibility and overall user experience, while providing a high quality digital audio signal from the aircraft panel intercom. Creating a mono signal for selected voice frequencies improves speech intelligibility while maintaining high quality stereo sound for music playback. Battery status for powering wireless components of the system is indicated by LEDs and also by audible alerts so that the user is aware of a low battery condition and may deploy an optional backup cord to bypass active circuitry and connect the headset directly to the aircraft panel.

The above advantages and other advantages and features may be recognized by those of ordinary skill in the art based on the following description of one or more representative embodiments taken in connection with the accompanying drawings.

### BRIEF DESCRIPTION OF THE DRAWINGS

FIG. 1 is a diagram illustrating a cross-section of a circumaural earcup embodiment of a representative wireless ANR headset system;

FIG. 2 is a control system block diagram illustrating representative ANR circuitry for use in embodiments of a wireless aviation headset system;

FIG. 3 is a block diagram illustrating operation of a wireless aviation headset system or method according to a representative embodiment;

FIG. 4 is a block diagram illustrating operation of a cross-feed system or method for improving speech intelligibility according to a representative embodiment; and

FIG. 5 is a flow chart illustrating operation of a wireless aviation communication system or method according to a representative embodiment.

### DETAILED DESCRIPTION

As required, detailed embodiments are disclosed herein; however, it is to be understood that the disclosed embodiments are merely representative and the claimed subject matter may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

The representative embodiments used in the illustrations relate generally to wireless active noise reduction headphones or headsets that may be implemented by circumaural, supra-aural, or in-the-ear type devices. Similarly, representative embodiments include an audio microphone that may be positioned by an adjustable boom or may be attached or contained within another system component to capture user voice or speech signals. Of course, those of ordinary skill in the art may recognize similar wireless applications or implementations consistent with the teachings of the present disclosure although not specifically illustrated or described.

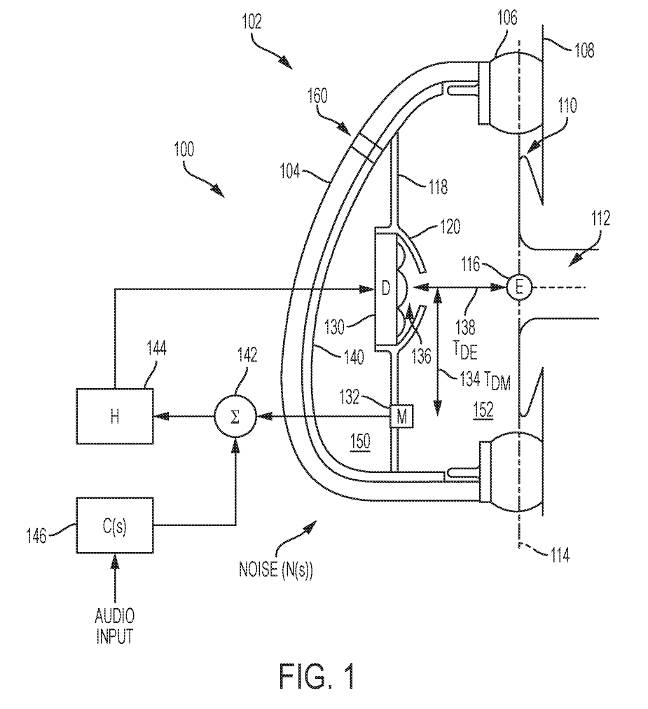

FIG. 1 is a diagram illustrating a cross-section of a circumaural earcup embodiment of a representative wireless ANR headset system. System 100 is implemented in a circumaural headphone with a boom microphone according to one embodiment. System 100 includes a pair of ear cups 102 (only one of which is shown) connected by a headband (not shown). Each ear cup 102 includes a shell 104 having a cushion 106 around the periphery of a front opening that forms a seal against head 108 of a user or observer and generally surrounds the pinna of the user's ear 110. Depending on the particular application and implementation, shell 104 may include a layer 140 of material selected to provide additional passive attenuation and/or desired structural characteristics for ear cup 104. Cushion 106 may be made of various types of materials that may have an associated compliance characteristic selected for a particular application to reduce or eliminate acoustic leak paths and provide a sealed cavity or chamber 152 surrounding ear 110. For example, cushion 106 may be manufactured from a viscoelastic material or foam and may include an additional covering or skin (not shown) to enhance durability, comfort, aesthetics, or various other system characteristics. An ear sense reference point or region 116 is defined for purposes of design, analysis, and evaluation to be just in front of the opening of ear canal 112. In the illustrated embodiment, ear sense point or region 116 may be located along the plane 114 passing through the compression centroid of cushion 106 and generally concentrically aligned with ear canal 112.

In the embodiment illustrated in FIG. 1, a compound or dual cavity ear cup 102 includes a front cavity 152 formed by a baffle or faceplate 118 that cooperates with speaker/driver (D) 130 and sense microphone 132 to separate back cavity 150 from front cavity 152. However, those of ordinary skill in the art will recognize that a wireless headset according to embodiments of the present disclosure may be implemented with different features than shown. Faceplate 118 may include an optional shroud 120 covering a diaphragm 136 of driver 130. Driver 130 and ANR sensing microphone 132 may be positioned relative to ear sense region 116 so that the phase of residual noise associated with a noise source (N(s)) arrives to some degree out of phase relative to the attenuating pressure waves from driver 130 at ear sense region 116. In one embodiment, this is accomplished by positioning driver 130 and ANR sensing microphone 132 relative to ear sense region 116 such that a first distance 134 from driver 130 to ANR sense microphone 132 exceeds a second distance 138 from driver 130 to ear sense region 116. However, wireless headsets according to various embodiments are generally independent of the particular position of driver 130 and ANR sensing microphone 132.

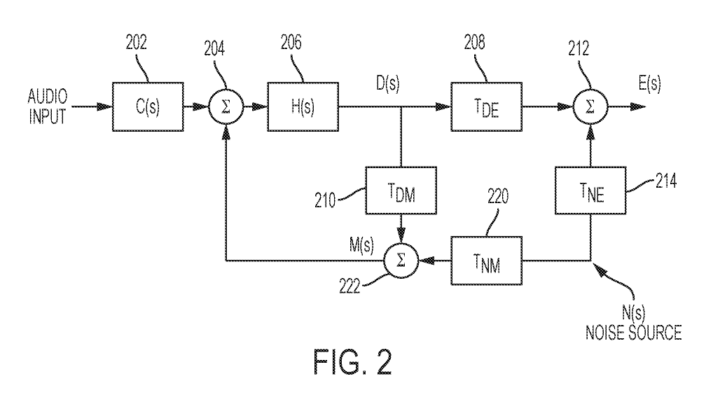

System 100 also includes various audio input and signal processing components/electronics in electrical communication with driver 130 and ANR sensing microphone 132 to implement closed loop feedback control and actively attenuate noise represented by N(s) at ear sensing region or point 116 as generally described with reference to FIGS. 2-4. An audio input signal characterized by C(s) and representing an external signal from a radio, music player, mobile phone, or similar device may be combined with the feedback signal from sensing microphone 132 as represented by block 142. However, those of ordinary skill in the art will recognize that ANR system performance and the wireless operation of the headset and panel interface described herein are generally independent of any such signal. One or more compensation filters, amplifiers, and other electronic components or devices represented by H in block 144, generally referred to as ANR circuits or circuitry, process the signal from microphone 132 for driver 130 to generate an acoustic signal or pressure wave having an amplitude and phase that attenuate the noise perceived at ear sense region 116. Noise represented by N(s) may enter front cavity 152 through various mechanisms associated with movement of ear cup 104 as well as through any leak paths, including any vents 160 provided to equalize pressure and acoustically tune the frequency response of system 100.

To accurately describe the real attenuation obtained “at the ear” of a closed loop noise reduction system 100 such as shown in FIG. 1, a reference point or region is selected for design, analysis, and testing/evaluation. In the representative embodiment of a circumaural headphone application, ear sense reference point or region 116 is positioned just outside the ear canal as previously described. The system analysis and operation is described with respect to the system level block diagrams and flowchart shown in FIGS. 2-5. This is a generic system level diagram that provides a mathematical estimate of real performance using systems analysis. Of course, other analysis techniques may be used in designing or evaluating such systems. As previously described, in the following analysis, the audio input characterized by C(s) of block 202 represents a communication signal that may be provided by a radio, music player, telephone, or other device, but has been omitted from the analysis for simplicity. Although an ear sense point just in front of the ear canal opening is provided to illustrate the concepts of the present disclosure, the system block diagram and analysis is independent of the position of the particular selected ear sense reference points, which could be within the ear canal or at the ear drum, for example.

The system with a null audio input can be described according to the following equations:

$$\begin{matrix}\frac{E ( s )}{N ( s )} = {T}_{NE} + \frac{{T}_{NM} {T}_{DE} H}{1 - {HT}_{DM}} \\ = {T}_{NE} \cdot {T}_{ANR} ( Eq . 2 )\end{matrix} \qquad ( Eq . 1 )$$

where T_{NE} represents the passive attenuation provided without active noise reduction, i.e. the resultant sound pressure at the ear caused by an outside noise source with the active noise reduction loop open (H=0), and T_{ANR} represents the transfer function of the active noise reduction system measured at the ear sense position illustrated in FIG. 1. In general, T_{ANR} may be represented by:

$$\frac{E ( s )}{N ( s ) {T}_{NE}} = ( 1 - \frac{H ( {T}_{DM} - \frac{{T}_{DE} {T}_{NM}}{{T}_{NE}} )}{1 - {HT}_{DM}} ) \qquad ( Eq . 3 )$$

where T_{DM} represents the transfer function from the ANR driver/speaker to the sense microphone, T_{DE} represents the transfer function from the driver/speaker to the ear sensing point, and T_{NM} represents the transfer function from the noise source to the sense microphone.

The four functions, T_{DM}, T_{DE}, T_{NM}, and T_{NE} can be analytically specified and/or measured by one of ordinary skill in the art. This equation is robust and may be adapted for use in a wide variety of applications that may or may not use similar assumptions and/or approximations as those described to simplify the analysis with respect to various representative embodiments. Those of ordinary skill in the art will recognize that this equation does not account for the direction of the noise source, which is generally not a significant source of error in applications or implementations where the direct sound paths for the noise to enter (i.e. leaks) are much smaller relative to noise caused by cup motion. In an ear bud or in-the-ear type closed loop active noise reduction system, the ear sensing point could be located within the ear canal or at the ear drum rather than just outside the ear, in which case T_{NE}, and T_{DE} may be more difficult to measure. While measurement at the ear sensing point may be useful to characterize the performance of the system during design and development, actual implementations generally do not include a device that measures the pressure at the ear drum and such a device is not required for operation of the embodiments of the present disclosure.

To simplify the analysis for circumaural headphones, both the magnitude and phase variations as a function of position in the front cavity are considered to be constant for front cavity pressures caused by outside noise sources. It can be seen from equation 3 that if the ear sense point is moved into the ear canal to the ear drum, then both T_{DE} and T_{NE} would experience a longer travel time and a similar filtering effect of the ear canal. According to equation 3, these effects cancel one another because they appear as a ratio of T_{DE} and T_{NE}.

Equation 3 is robust without the constant amplitude/phase assumption and may be used to describe the behavior of applications having more significant leaks or noise paths where amplitude and phase of the pressure wave associated with a noise source may exhibit greater variation. For example, supra-aural headphone designs often have significant leaks or noise paths. Likewise, in-the-ear designs may exhibit more phase variation and some amplitude variation associated with noise leak paths through a rear vent of the driver or a pressure relief vent, for example. Equation 3 may be used in analyzing these types of applications although the interpretation may be more complex than for the representative circumaural embodiments described herein.

For applications with good passive attenuation, such as various circumaural headphone applications, for example, T_{NE}≈T_{NM} and Equation 3 provides the following:

$$\begin{matrix}{T}_{ANR ( s )}^{′} ≡ \frac{1}{{T}_{NE}} \cdot \frac{E ( s )}{N ( s )} = 1 + \frac{{HT}_{DE}}{1 - {HT}_{DM}} = \frac{1 - H ( {T}_{DM} - {T}_{DE} )}{1 - {HT}_{DM}} \\ where \text{:} & ( Eq . 4 ) \\ {T}_{ANR}^{′} ≡ {T}_{ANR} {\vert}_{{T}_{NM} = {T}_{NE}} & ( Eq . 5 )\end{matrix}$$

Referring now to the block diagram of FIG. 2 that illustrates a generalized control system for active noise reduction that may be used in a wireless aviation headset according to embodiments of the present disclosure, an audio input may be provided as represented by the communication signal transfer function C(s) of block 202. As previously described, the communication signal may represent any type of electrical signal associated with a radio, music player, or telephone, for example, that is provided for the driver/speaker to provide corresponding sound to the user. Some applications may include a separate speaker for communications such that the signal is not electrically combined with the ANR control signal. For applications that use the same speaker/driver 130 (FIG. 1) for audio/sound communications and noise reduction, the audio input signal may be combined or added to the feedback signal at block 204. However, the audio signal does not affect the operation of the ANR system and has been omitted for convenience to simplify the analysis.

As also illustrated in FIG. 2, the feedback signal M(s) of the ANR microphone has an associated transfer function T_{DM} relative to the driver/speaker that combines with the noise source N(s) as represented by block 222 and is fed back through block 204. The combined signal is processed by one or more compensation filters, power amplifiers, and various electronics represented by H(s) of block 206 with the resulting signal represented by D(s) provided to the driver/speaker whose transfer function with respect to the ear sense point is represented by T_{DE} of block 208. The driver/speaker output is combined at block 212 with the noise source as represented by the transfer function relative to the ear sense point T_{HE} of block 214 with the resulting output to the ear sense point as represented by E(s).

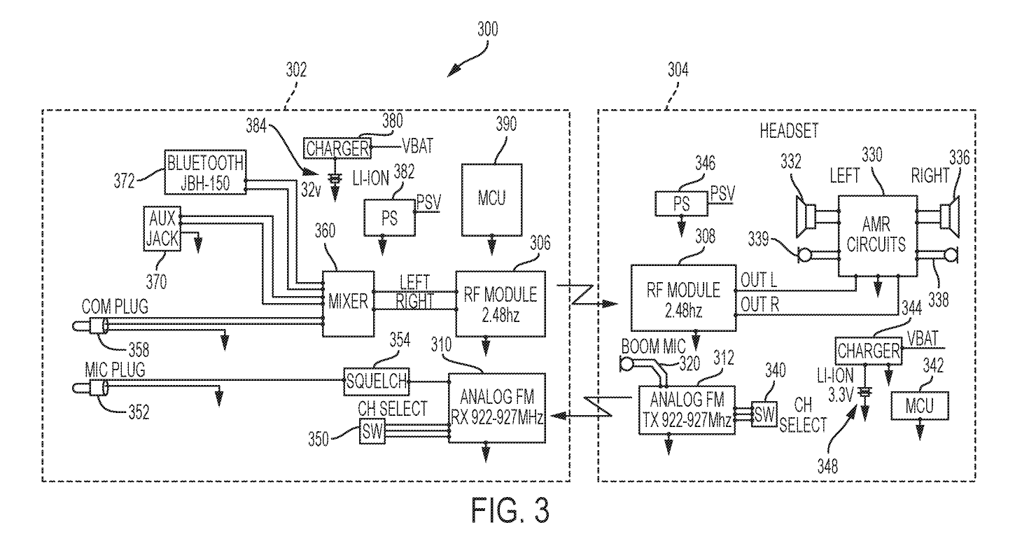

FIG. 3 is a block diagram illustrating operation of a wireless aviation headset system or method according to a representative embodiment. System 300 includes an aircraft panel interface module 302 that communicates wirelessly with an associated ANR headset 304. Interface module 302 includes a digital transmitter 306 that transmits a digital signal at a nominal frequency of 2.4 GHz in one embodiment. The digital signal is received by a corresponding digital signal receiver 308 of headset 304 that operates at a corresponding nominal frequency of 2.4 GHz. Interface module 302 also includes an analog receiver 310 that receives a signal associated with a selected analog channel from an associated analog transmitter 312 of headset 304. Analog receiver 310 and analog transmitter 312 operate at a channel selected by an associated software module 350 and 340, respectively, within a frequency range of 922 MHz to 927 MHz, for example, which may depend upon the particular geographic region. In another embodiment, the channel selected by the associated software module 350 and 340 uses the 800 MHz band. A voice microphone 320 may provide associated voice or speech signals to analog transmitter 312. In one embodiment, voice microphone 320 is a boom microphone positioned on a boom connected to a left or right earcup of a circumaural headset. In one embodiment, the headset is reversible allowing the boom to be used on the right or left side.

ANR circuitry 330 is coupled to digital receiver 308 as well as to a left driver 332, a left sense or ANR microphone 334, a right driver 336 and a right sense or ANR microphone 338. ANR circuitry 330 may include hardware and/or software components that generate signals in response to noise signals from ANR microphones 334, 338 that have similar amplitude and opposite phase and provide the signals to drivers 332, 336, respectively, to reduce or cancel noise perceived by the user. Representative characteristics and operation of ANR circuitry is illustrated and described above with respect to FIGS. 1 and 2, for example. Drivers 332, 336 (which may also be referred to as speakers) may receive audio signals corresponding to speech or music received from interface module 302 via digital receiver 308 as described in greater detail herein. As generally illustrated in FIG. 3, audio and speech signals may be provided as a left channel signal (OUT L) and a right channel signal (OUT R) for left driver 332 and right driver 336, respectively.

Headset 304 may include a microprocessor or microcontroller based control unit or controller 342 that may be programmed to perform or implement various system control functions or features. Various system components may be powered by a power supply 346, which may be supplied by an optional external corded connection, or may be supplied by a battery and associated battery box 348. In some embodiments, a battery charger 344 may be coupled to the battery and battery box 348 for wired or wireless battery charging.

Analog receiver 310 of aircraft panel interface module 302 may be connected to a squelch control 345 and coupled to a microphone output plug 352 configured for wired connection to an aircraft panel microphone input. Similarly, a wired communications or intercom input plug 358 may be configured to connect to an aircraft panel communications output. Input 358 is connected to a mixer 360 that may be used to control the relative signal strength (amplitude) or volume of signals from plug 358 relative to an auxiliary input signal from auxiliary input 370 and a wireless signal associated with a wirelessly linked mobile device through an associated interface, such as Bluetooth interface 372, for example. Interface module 302 also includes a power supply 382 that supplies power to various system components from a battery box and associated battery 384. A battery charger 380 may also be provided to provide a wired or wireless charging connection to battery box and battery 384. Interface module 302 also includes a microprocessor based controller or control unit 390 programmed to perform or implement various system features or functions as generally described herein.

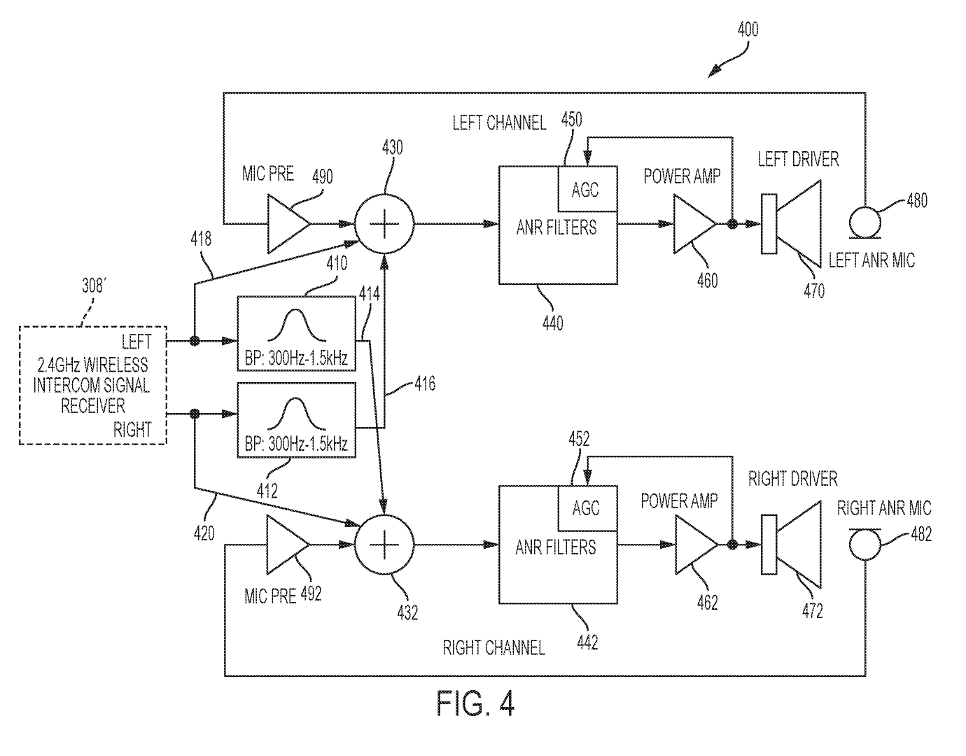

FIG. 4 is a block diagram illustrating operation of a cross-feed system or method for improving speech intelligibility according to a representative embodiment. System 400 may be implemented within a wireless aviation ANR headset as previously described. System 400 receives left channel and right channel audio signals from a wireless receiver 308′, implemented by a digital wireless receiver in the representative embodiment illustrated. Left channel signal 481 and right channel signal 420 are provided to corresponding bandpass filters 410, 412 as well as summing or combining circuitry 430, 432. The bandpass filtered left channel signal 414 is combined with the unfiltered right channel signal 420 at block 432. Similarly, the bandpass filtered right channel signal 416 is combined with the unfiltered left channel signal 418 at block 430. The bandpass filters 410, 412 are tuned to pass frequencies associated with voice or speech signals in the range of 300 Hz to 1.5 kHz, for example. The combination of the filtered and unfiltered frequencies results in an essentially mono signal for speech or voice to improve intelligibility while maintaining a high quality stereo signal for music.

As also shown in FIG. 4, the outputs of blocks 430, 440 are provided to ANR filters 440, 442, which include associated automatic gain controls (AGC) 450, 452. The signals are provided to corresponding power amplifiers 460, 462 and left and right drivers 470, 472, respectively. Signals from sense or ANR microphones 480, 482 are fed back through respective microphone pre-amplifiers 490, 492, where they are combined by blocks 430, 432. As previously described ANR filters 440, 442 generate noise reducing or canceling signals in response to noise detected by associated ANR microphones 480, 482, respectively, that are similar amplitude and opposite phase of the detected noise signal to reduce or eliminate ambient noise perceived by the user.

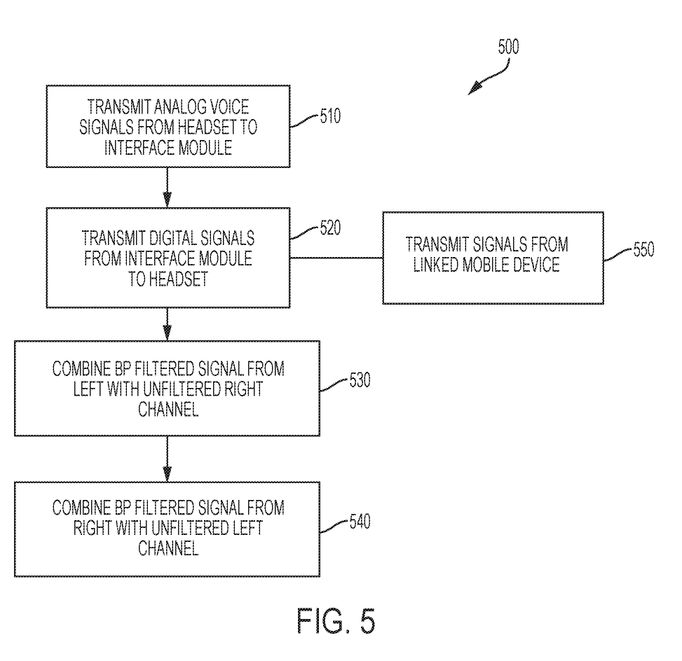

FIG. 5 is a flow chart illustrating operation of a wireless aviation communication system or method according to a representative embodiment. As generally understood by those of ordinary skill in the art, the method 500 may be implemented through hardware and/or software associated with a computer algorithm, machine executable code, or software instructions programmed into one or more suitable programmable logic devices associated with the headset and/or aircraft panel interface, such as MCU 342 or MCU 390, respectively. Although the various operations shown in the diagram 500 are illustrated in a sequential or chronological fashion, one or more of the operations or features may be performed in a different order, may be repeatedly performed, may be performed concurrently, or may not be performed depending on the particular application and implementation.

Operation of system or method 500 includes wirelessly transmitting analog voice signals from a headset to an analog receiver of an aircraft panel interface module configured for wired coupling to an aircraft panel as represented at 510, and wirelessly transmitting digital signals from the aircraft panel interface module to the headset as represented at 520. Operation of the system or method may include combining bandpass filtered signals from a left channel with unfiltered signals from a right channel of a headset digital receiver as represented at 530, and combining bandpass filtered signals from the right channel with unfiltered signals from the left channel of the headset digital receiver as represented at 540. The bandpass filtered signals may have frequencies between 300 Hz and 1.5 kHz, for example. Operation of the system or method may also include wirelessly transmitting digital signals from the aircraft panel interface module from a mobile device linked to the aircraft panel interface module as represented at 550.

While representative embodiments are described above, it is not intended that these embodiments describe all possible forms of the claimed subject matter. Rather, the words used in the specification are words of description rather than limitation, and it is understood that various changes may be made without departing from the spirit and scope of the disclosure. Additionally, the features of various implementing embodiments may be combined to form further embodiments that are not explicitly described or illustrated. While various embodiments may have been described as providing advantages or being preferred over other embodiments or prior art implementations with respect to one or more desired characteristics, as one of ordinary skill in the art is aware, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. Embodiments described as less desirable than other embodiments or prior art implementations with respect to one or more characteristics are not necessarily outside the scope of the disclosure and may be desirable for particular applications. While representative embodiments have been described with respect to a wireless aviation headset, various features within the scope of the claimed subject matter may be employed in other applications.

What is claimed is:

1. An aircraft wireless communication system comprising:
a headset comprising:
left and right active noise reduction (ANR) microphones;
ANR circuitry coupled to the left and right ANR microphones that processes signals from the ANR microphones to generate corresponding driver signals in response to the signals from the ANR microphones;
left and right drivers coupled to the ANR circuitry that receive respective left and right driver signals;
a digital receiver coupled to the ANR circuitry;
a voice microphone; and
an analog transmitter coupled to the voice microphone;
and
an aircraft panel interface comprising:
an analog receiver that receives wireless signals from the analog transmitter and provides corresponding signals to a wired output configured to connect to an aircraft panel; and
a digital transmitter connected to a wired input configured to connect to an aircraft panel and wirelessly transmit corresponding signals to the digital receiver.

2. The system of claim 1 wherein the digital transmitter and the digital receiver are configured to transmit and receive 2.4 GHz signals, respectively.

3. The system of claim 1 wherein the analog transmitter and the analog receiver are configured to transmit and receive analog signals, respectively, associated with a selected channel within a frequency range of 922-927 MHz.

4. The system of claim 1, the aircraft panel interface further comprising a Bluetooth receiver coupled to the digital transmitter.

5. The system of claim 1, the aircraft panel interface further comprising an auxiliary input coupled to the digital transmitter.

6. The system of claim 5 wherein the auxiliary input comprises a wired jack configured to receive a corresponding wired connector.

7. The system of claim 1, the headset further comprising:
a left channel bandpass filter that receives a left channel signal from the digital receiver and generates a filtered left channel signal;
a right channel bandpass filter that receives a right channel signal from the digital receiver and generates a filtered right channel signal;
left driver circuitry that combines the left channel signal with the filtered right channel signal; and
right driver circuitry that combines the right channel signal with the filtered left channel signal.

8. The system of claim 7, at least one of the left channel bandpass filter and the right channel bandpass filter having a bandpass frequency range of 300 Hz to 1.5 kHz.

9. The system of claim 1, the headset further comprising a battery box configured to receive a battery to power the ANR circuitry.

10. A wireless aircraft communication system, comprising:
a headset including left and right circumaural earcups having left and right sense microphones and left and right drivers, respectively, noise reduction circuitry having filters to generate noise reduction signals for the left and right drivers in response to signals received from the left and right sense microphones, respectively, a boom microphone, a wireless digital receiver coupled to the noise reduction circuitry, an analog transmitter coupled to the boom microphone transmitting analog signals, and crossover circuitry that combines selected frequencies from a right channel of the digital receiver with signals from a left channel of the digital receiver, and that combines selected frequencies from a left channel of the digital receiver with signals from a right channel of the digital receiver; and
an aircraft panel interface having an analog receiver coupled to an aircraft panel input plug and a digital transmitter coupled to an aircraft panel output plug.

11. The wireless aircraft communication system of claim 10 further comprising a transceiver configured to wirelessly link a mobile device to the digital transmitter.

12. The wireless aircraft communication system of claim 10 further comprising an auxiliary device input coupled to the digital transmitter.

13. The wireless aircraft communication system of claim 10, the digital transmitter and the digital receiver operating at a nominal frequency of 2.4 GHz.

14. The wireless aircraft communication system of claim 10, the analog transmitter and the analog receiver operating at a selected channel within a frequency range of between 922 Mhz and 977 Mhz.

15. The wireless aircraft communication system of claim 10, the crossover circuitry comprising bandpass filters having a bandpass frequency range of 300 Hz to 1.5 kHz.

16. A method for aircraft wireless communication, comprising:
wirelessly transmitting analog voice signals from a headset to an analog receiver of an aircraft panel interface module configured for wired coupling to an aircraft panel; and
wirelessly transmitting digital signals from the aircraft panel interface module to the headset.

17. The method of claim 16 further comprising:
combining bandpass filtered signals from a left channel with unfiltered signals from a right channel of a headset digital receiver; and
combining bandpass filtered signals from the right channel with unfiltered signals from the left channel of the headset digital receiver.

18. The method of claim 17, the bandpass filtered signals being filtered to pass frequencies between 300 Hz and 1.5 kHz.

19. The method of claim 18 wherein the aircraft panel interface module wirelessly links to the mobile device.

20. The method of claim 16 further comprising wirelessly transmitting digital signals from the aircraft panel interface module from a mobile device linked to the aircraft panel interface module.
